(19) United States
(12) Patent Application Publication
(10) Pub. No.: US 2017/0156303 A1
(43) Pub. Date: Jun. 8, 2017

(54) INSECT TRAP

(71) Applicant: Dana F. COOPER, Selbyville, DE (US)

(72) Inventor: Dana F. COOPER, Selbyville, DE (US)

(21) Appl. No.: 15/366,082

(22) Filed: Dec. 1, 2016

Related U.S. Application Data
(60) Provisional application No. 62/262,838, filed on Dec. 3, 2015.

(51) Int. Cl. A01M 1/14

(52) U.S. Cl. CPC A01M 1/145

(57) ABSTRACT

An insect trap body, polygonal in cross-section, having a light source inside and a closed top with an attachment means for hanging. A translucent removable sticky surface surrounded by a structural support material having a tab forming a card, which card is capable of being inserted into channels on at least one side of the insect trap polygonal body. Insects adhere to the sticky surface of the card while being attracted by the light source. The translucent sticky membrane and support card can be removed from the insect trap body and replaced by a new one when necessary.

### BACKGROUND

Insect traps come in many different embodiments and many of them attract the insects, kill them by an electrical source, and they drop to the ground and have to be cleaned up. Other traps are as simple as hanging fly paper, usually having an insect attractive scent, the insects are adhered to the sticky surface of the fly paper and the fly paper is disposed of as necessary. Another type of insect trap is an enclosed container, with a light source inside, and a peripheral side of a translucent sticky membrane. The insects, attracted by the light source adhere to the sticky surface and the complete sticky surface of whatever shape, is removed and replaced.

### PRIOR ART

There are many pieces of prior art for insect traps having a light source on the inside of a container and a sticky membrane surrounding it, U.S. Pat. No. 2,305,898 collapsible, can be hung and once a light source is placed in it, the insects are trapped on a translucent sticky surface and the trap is then thrown away, U.S. Pat. No. 6,481,152 shows a hardwired light source, preferably fluorescent, in a cylinder with a removable larger diameter translucent sticky cylinder on which the insects are trapped. A person simply removes the sticky cylinder and replaces it with another one. Other pieces of prior art are U.S. Pat. No. 6,758,009 and US publication 2012/0167450 all teaching an insect trap with a light source and a sticky membrane.

### SUMMARY OF THE INVENTION

In all of the above discussed prior art, if the insect trap is not thrown away when full of insects then at least the sticky membrane is thrown away and a new sticky membrane is inserted into the trap. The instant invention has a more economical and practical solution. It is polygonal in shape, preferably square in cross-section, and there are translucent removable sticky surfaces surrounded by a structural support for each of the polygonal surfaces. There is also a tab for removing the translucent removable sticky surface and support structure so that when one of the polygonal sides is covered with insects, it can be removed and replaced without removing all of the other translucent removable sticky surfaces and structural supports thereby money is saved. All of the translucent removable sticky surfaces need not be replaced but only select ones on each side of the polygonal cross-section insect trap.

### BRIEF DESCRIPTION OF THE DRAWINGS

FIG. 1 is a front perspective view of the insect trap.

FIG. 2 is a side elevational view of the insect trap.

FIG. 3 is cross-sectional view taken along lines 3-3 in FIG. 2.

FIG. 4 is perspective view of the translucent removable sticky surface having a peripheral structural support and a tab for removing.

### DETAILED DESCRIPTION OF PREFERRED EMBODIMENTS

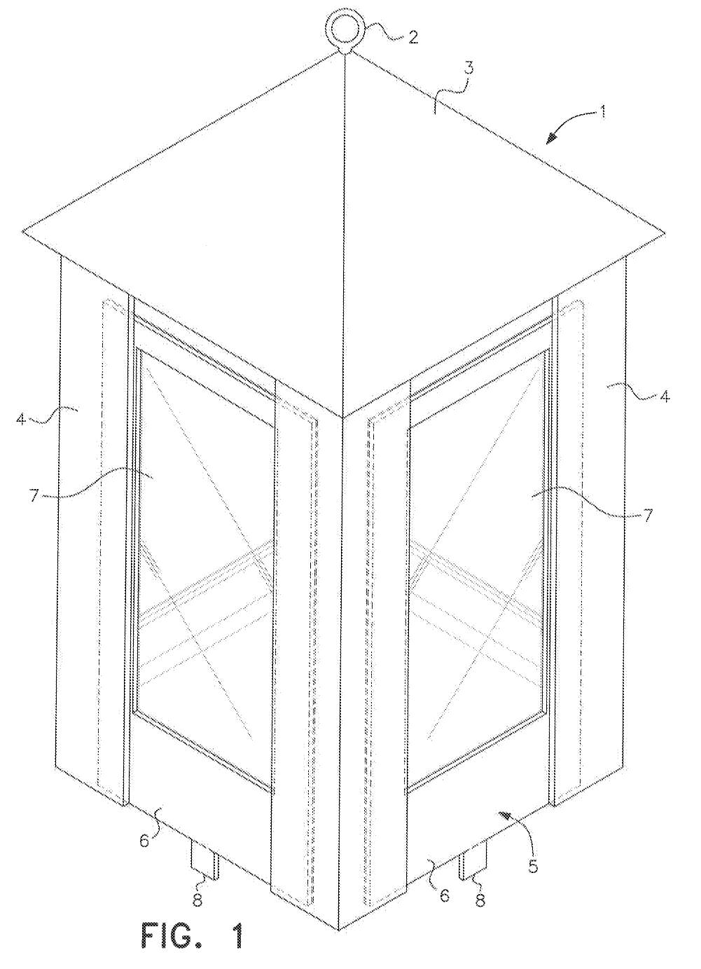

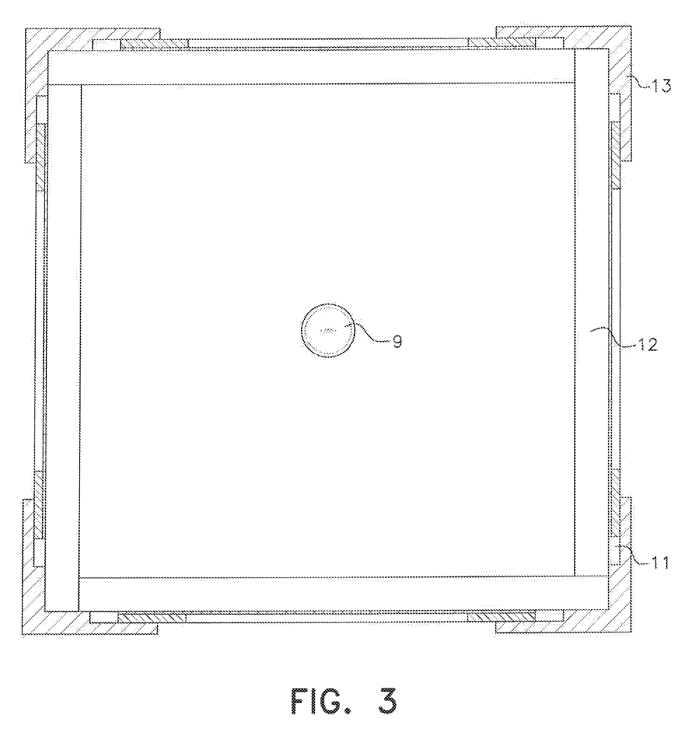

FIG. 1 shows an insect trap 1 having an enclosed top surface 3 with an attachment means 2. In this embodiment, there are four sides of the polygonal cross-section. It will be seen that all of the sides 4 have a card 5 made up of a translucent sticky membrane 7 surrounded by structurally supportive material 6 and a tab 8 for removing the above mentioned elements. Card 5 is inserted into channels 11 as seen in FIG. 3 and the channels 11 are formed between the body 12 and an outer support structure 13. The body 12 and outer support structure 13 can be separate pieces as shown adhered together or can be integral.

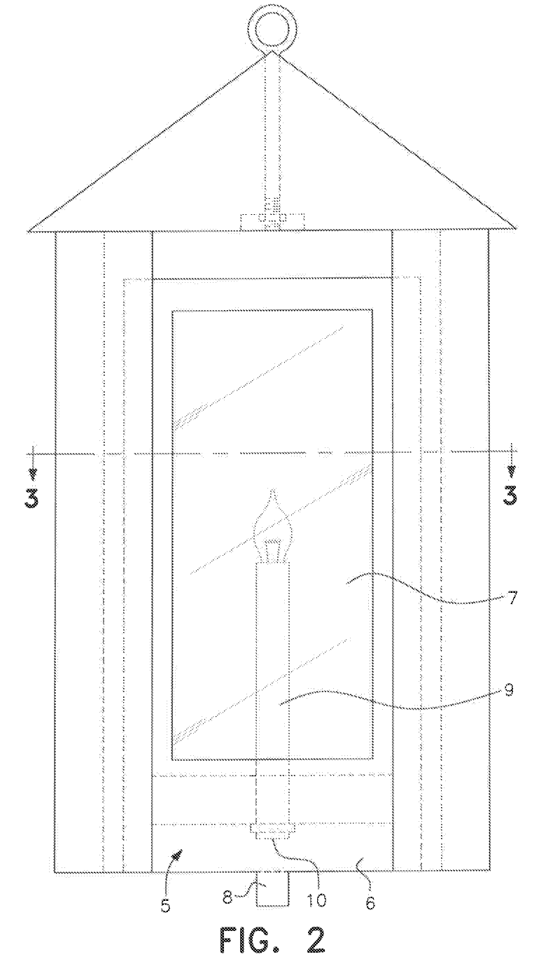

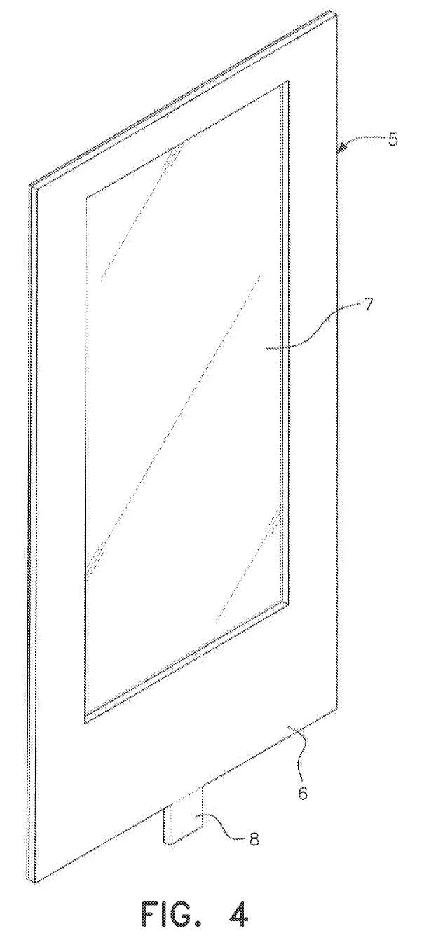

There is a light source 9 with an on/off switch mechanism 10 best seen in FIG. 2. The card 5, best seen in FIG. 4 is made up of the translucent sticky membrane 7 and support materials 6 surrounding the translucent sticky membrane 7. The supporting structure has a tab 8 for allowing the insertion and removal of the card 5 unto the channels 11 so that each attic polygonal sides of the insect trap can be individually replaced with a card 5. Preferably the sticky side of translucent membrane 7 is on lie inside and not the outside of the card 5 so that if the insect trap were to fall on its side it would not pick up debris. The support structure has to be strong, enough to permit the insertion and retraction of the card 5 into and out of channels 11. Cardboard or other inexpensive material can be used.

The light source can be of any type, incandescent, fluorescent, LED and preferably it is battery operated and must have an on/off mechanism. The light source 9 can also be solar with the panels making up the top enclosure 3. The attachment means 2 is shown as a bolt having an eye but it can be of any known type, string, Velcro, etc.

The preferred polygonal in cross-section embodiment of the insect trap is four sided but could be three sided, five sided or indeed any number of sides within reason. The important thing is that each side has an insertable card 5 with a structural support surround 6 and tab 8 so that it may be inserted into the channels “of the insect trap” and removed when necessary. This means that not all of the cards 5 need be removed but rather only the card with the large number of insect adhered to the sticky surface need be removed and replaced giving greater convenience and economic advantage. A single card 5 is cheaper than any of the complete sticky surfaces in the prior art.

The insect trap could have legs on the bottom and no attachment means on the top whereby it could stand on a flat surface allowing the insects to come in from the bottom and be trapped on the translucent sticky surface 7.

I claim:

1. An insect trap container, polygonal in cross-section, having a light source inside and a closed top; a translucent removable sticky surface surrounded by a structural support material having a tab forming a card; the insect trap container having channels on each polygonal side into which channels the card is removably insertable; wherein when one of the cards are covered with insects it can be removed and replaced with a new card.
